(19) United States
(12) Patent Application Publication
(10) Pub. No.: US 2013/0235617 A1
(43) Pub. Date: Sep. 12, 2013

(54) LED EDGE-LIT SIGNAGE UTILIZING DIGITAL PRINT TECHNOLOGY

(71) Applicants: Jon-Paul Bussoli, Calgary (CA); Richard Brown, Calgary (CA)

(72) Inventors: Jon-Paul Bussoli, Calgary (CA); Richard Brown, Calgary (CA)

(73) Assignee: CARMANAH SIGNS INC., Calgary (CA)

(21) Appl. No.: 13/603,163

(22) Filed: Sep. 4, 2012

Related U.S. Application Data
(63) Continuation-in-part of application No. 12/722,781, filed on Mar. 12, 2010, now abandoned.

(51) Int. Cl. F21V 8/00

(52) U.S. Cl. CPC G02B 6/0068
USPC 362/613

(57) ABSTRACT

A display assembly combines a digital display with an edge-lit illuminated faceplate, using light sources mounted around the digital display. The light sources direct illumination radially outwardly of the digital display and into the edge of the faceplate. An intermediate housing may accommodate the digital display, the light sources and the faceplate. The light sources are configurable and the digital display may be programmed to create zones with different content and customizable according to schedules of operation.

### CROSS REFERENCE TO RELATED APPLICATIONS

This application is a continuation-in-part of U.S. patent application Ser. No. 12/722,781, filed Mar. 12, 2010.

### FIELD OF THE INVENTION

This invention relates to illuminated signage. In particular, this invention relates to illuminated signage with LED edge lighting.

### BACKGROUND OF THE INVENTION

Illuminated image signage is used where there is insufficient illumination at night for a sign to be seen, or where increased awareness of the sign is desired. Increasingly, image signage is being illuminated using LED edge-lighting. LEDs offer low voltage DC operation, low power consumption, long life without maintenance, and rugged construction that is immune to vibration and shock.

Edge lighting with LEDs provides the additional advantage of enabling extremely thin signs that are esthetically pleasing. LEDs are well suited to such applications because of their small size and directional propagation of light.

The association of LED edge-lit print-based signage with a changeable digital display offers the opportunity to provide the attraction of an aesthetically pleasing edge-lit sign along with the flexible content available through a changeable digital display.

U.S. Patent Publication No. 2011/0279357 to Leeks discloses a display assembly with top and bottom display portions. The top display portion comprises a digital LED scroller unit, while the bottom display portion comprises a printed panel. The printed panel is lit by lighting from the LED scroller unit. The contents of the LED scroller unit may be adjusted and controlled through wireless communications. However, as the printed panel is illuminated only on one edge by incidental lighting, its illumination may appear uneven. Furthermore, the LED scroller unit is limited in its display capabilities to mainly textual information in a static or scrolling form.

It is therefore an object of this invention to provide an effective visual display that includes a properly illuminated LED edge-lit sign as well as a changeable digital display whose contents and layout can easily be customized and adjusted.

These and other objects of the invention will be better understood by reference to the detailed description of the preferred embodiment which follows. Note that not all of the objects are necessarily met by all embodiments of the invention described below or by the invention defined by each of the claims.

### SUMMARY OF THE INVENTION

In one aspect, the invention comprises a display assembly having a centrally disposed changeable digital display and a surrounding edge-lit panel, the lighting being directed perimetrally outward from the digital display into the inside edges of the surrounding static image panel.

In another aspect, a plurality of light sources are arranged around the perimeter of the digital display, the light sources being directed radially outward from the digital display into the inside edges of the surrounding edge-lit panel.

In another aspect, the digital display is mounted in a housing. The housing includes a perimetral channel in which the outwardly directed light sources are housed.

In yet a more particular aspect, the channel includes an outer wall against which the edge-lit panel abuts. In another aspect, the outer wall is provided with an unveven surface to enhance diffusion of the light traversing the wall into the edge of the edge-lit panel.

In a further aspect, a bezel is secured to the housing to mask the light sources from viewing from the front of the display assembly.

In another aspect, the digital display may be configured to segregate the display into a plurality of separately defined zones, each of which may be assigned a shape, size, layout, content or a schedule independently of the other zones.

In yet another aspect, the display assembly may be configured to determine the mode of operation of the light sources that illuminate the panel or faceplate and according to a user-defined schedule.

The foregoing was intended as a broad summary only and of only some of the aspects of the invention. It was not intended to define the limits or requirements of the invention. Other aspects of the invention will be appreciated by reference to the detailed description of the preferred embodiment, including the drawings, whether or not those aspects are summarized in this section.

### BRIEF DESCRIPTION OF THE DRAWINGS

The invention will be described by reference to the detailed description of the preferred embodiment and to the drawings thereof in which:

FIG. 1 is a perspective view of a top edge-lit LED light panel used in the preferred embodiment of the invention;

FIG. 2 is a perspective view of a portion of the light panel of FIG. 1 illustrating internal reflection from an edge of the panel;

FIG. 3 is a perspective view of a portion of the light panel showing a matrix of light-diffusing hexagon dots on the front surface of the panel;

FIG. 4 is an exploded view of an illuminated sign according to the preferred embodiment;

FIG. 5 is a rear perspective view of an image-carrying sheet according to the preferred embodiment;

FIG. 6 illustrates a completed sign with images according to the preferred embodiment, including the use of clear windows to present a variable digital display component of the image;

FIG. 7 is a front perspective view of a display assembly according to an alternative embodiment of the invention;

FIG. 8 is a front view of a display assembly according to the alternative embodiment with a faceplate of a different shape and having a different static image thereon, and without the rear chassis and pedestal;

FIG. 9 is a rear perspective view of the digital display mounted in a housing and further comprising a plurality of light sources secured around the perimeter of the digital display by means of a chassis seated in a perimetral channel of the housing, with the light sources directed radially outward from the digital display;

FIG. 10 is a an enlarged view of a corner of the structure of FIG. 9 more clearly showing the light sources;

FIG. 11 is a close up perspective view of the structure of FIG. 9 more clearly showing the channel and the seating of the chassis and light sources therein;

FIG. 12 is a substantially edge view of the faceplate portion of the display assembly;

FIG. 13 is a substantially front view of the faceplate;

FIG. 14 shows the display assembly without the bezel and with the faceplate only partially mounted on the housing so as to reveal the inside edge of the faceplate in relation to the light sources seated in the housing;

FIG. 15 shows the digital display seated in the housing;

FIG. 16 is a close up view of a corner of the housing with the digital display seated therein and more clearly showing the perimatral channel of the housing;

FIG. 17 is a close up view of an edge of the housing showing the transparent outer wall of the housing channel and the light sources visible therethrough. The rear chassis of the display assembly is also partially visible in this view;

FIG. 18 is a front view of the display assembly without the rear chassis or the mount, but showing the digital display, the faceplate and the bezel;

FIG. 19 is an edge view of the assembly of FIG. 18;

FIG. 20 is a bottom view of the display assembly without the faceplate and with the bezel partially installed;

FIG. 21 is a bottom view of the display assembly without the faceplate and with the bezel installed;

FIG. 22 is a bottom edge view of one side of the display assembly without the faceplate and with the bezel installed showing the seat for receiving the faceplate;

FIG. 23 is a exploded perspective view of the chassis and the housing with the digital display seated in the housing;

FIG. 24 is a further perspective exploded view of the chassis and the housing with the digital display seated in the housing;

FIG. 25 is a rear view of the chassis and the light sources mounted thereon;

FIG. 26 is a bottom perspective view of the chassis and the light sources mounted thereon;

FIG. 27 is a top perpsective view of the chassis and the light sources mounted thereon;

FIG. 28 is a corner view of the digital display seated in the housing, with the faceplate installed against and on the housing, and a bezel partially mounted on the housing to retain the digital display and the faceplate;

FIG. 29 is a bottom view of the display assembly but not showing the entire lower mount;

FIG. 30 is a bottom perspective view of the display assembly but without the bezel such that the light sources are visible to a viewer of the assembly;

FIG. 31 is a partial view of the front of the digital display seated in the housing and showing the channel;

FIG. 32 is a rear view of the digital display seated in the housing and showing the ribbon connector;

FIG. 33 is partial edge view of faceplate mounted on the housing;

FIG. 34 is a further partial edge view of the faceplate mounted on the housing;

FIG. 35 is a partial front perspective view of the faceplate mounted on the housing and also showing the digital display seated in the housing;

FIG. 36 is an edge view of the faceplate being only partially installed against the outer wall of the housing;

FIG. 37 is a corner view of the housing with a partial view of the digital display seated therein and showing the aperture for receiving the bezel post;

FIG. 38 is a partial corner view of the housing, the digital display seated therein and the rear housing of the unit;

FIG. 39 is a front view of the rear housing, the lower mount and base and showing the circuit board mounted in the rear housing;

FIG. 40 is a rear view of the rear housing, the lower mount and the base;

FIG. 41 is a side view of the assembled display assembly;

FIG. 42 is a flowchart of the configuration steps for the digital display; and,

FIG. 43 illustrates various digital display zone assignments according to the invention.

### DETAILED DESCRIPTION OF THE PREFERRED EMBODIMENT

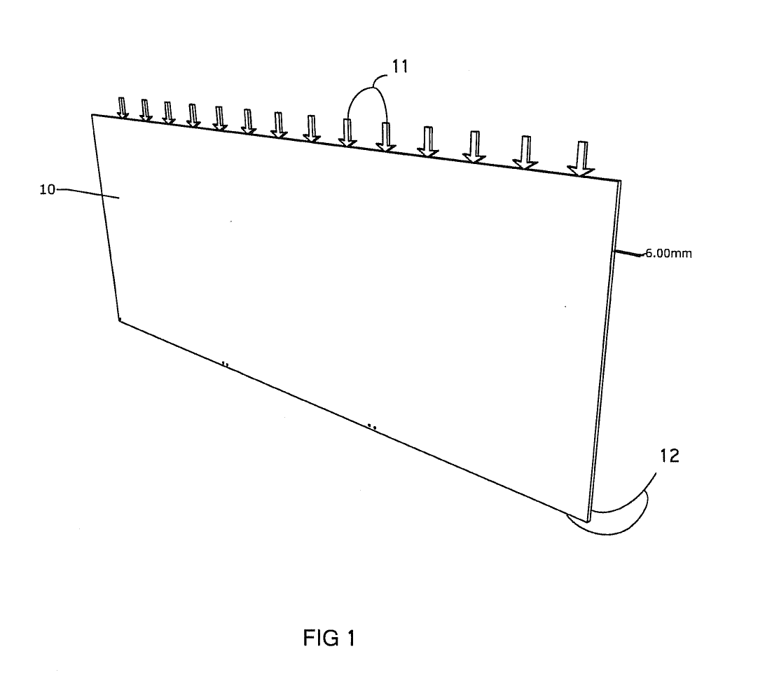

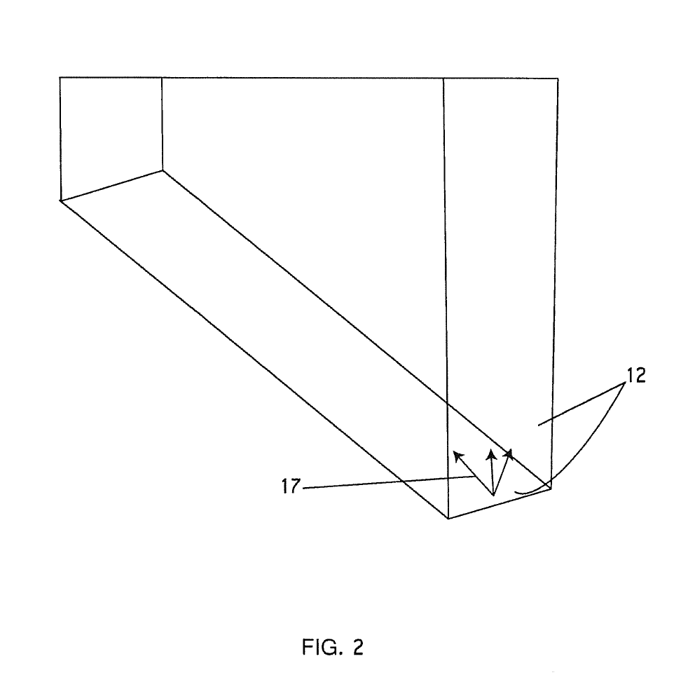

FIG. 1 illustrates a top edge-lit LED light panel 10 used in the preferred embodiment of the invention. Light panel 10 may consist of a single sheet of 6 mm transparent acrylic. As is known, LEDs are provided at or near one or more edges of the panel to propagate light within the body of the panel. The edges 12 of the sheet are typically provided with a reflective material (which may be white paint) to reflect the light internally (17) as illustrated in FIG. 2. In the preferred embodiment, the panel is lit (11) only from its top edge, but the invention is equally applicable to lighting from other edges or from a plurality of edges.

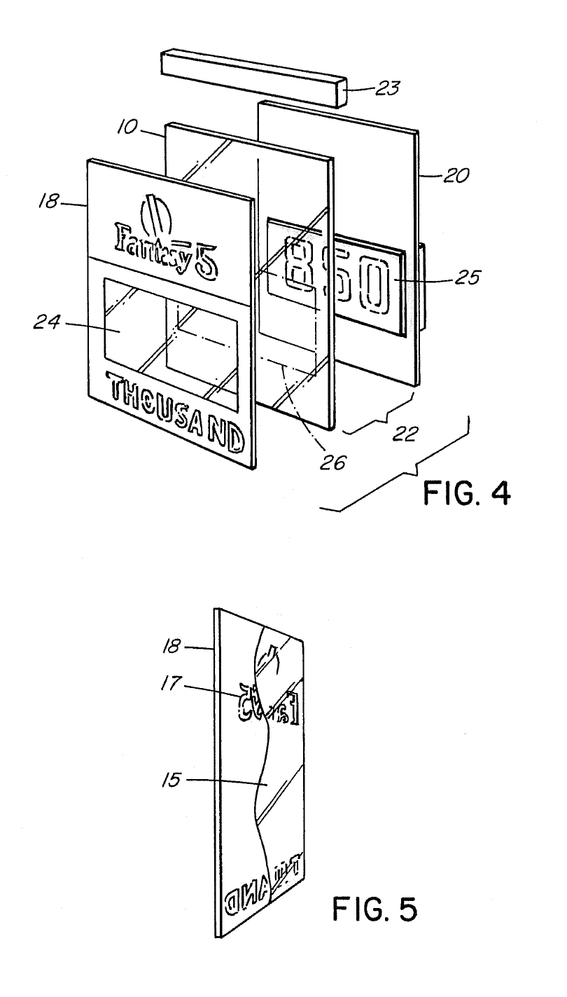

Referring to FIG. 4, the preferred embodiment includes an image-carrying sheet 18, the light panel 10 mounted co-planar with and to the print side of the image-carrying sheet 18 (opposite the viewing side of the image-carrying sheet 18) and a reflective back plate 20 mounted coplanar with and behind the light panel 10 (on the opposite side of the light panel from the image-carrying sheet). A gap 22 may be provided between the light panel 10 and the reflective back plate 20, as discussed below.

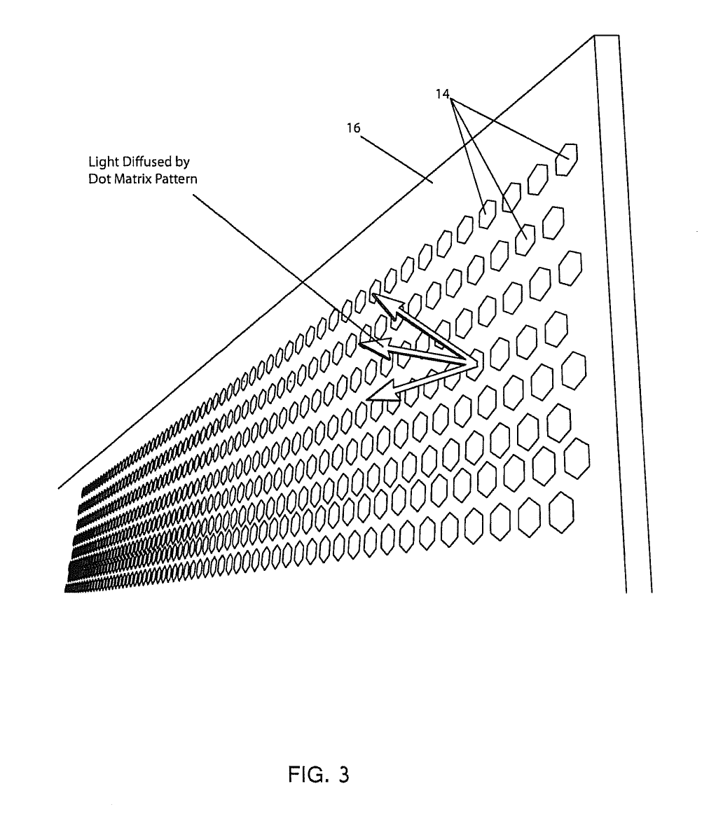

Referring now to FIG. 3, frontward diffusion of the light from the light panel may be provided by using a matrix of printed, engraved, silkscreened or etched elements such as dots 14 on the front surface (viewer side) of light panel 10 that faces the image-carrying sheet. The dots, which in the preferred embodiment are hexagonal, provide a diffusing rather than a reflective surface, allowing the light to pass through the front surface 16 of the panel.

Given that the preferred embodiment of the light panel is preferentially edge-lit from the top edge, in order to provide a uniform backlighting of the image the dot matrix is provided with a density gradient from a low density adjacent the lit edge to a high density distal from the lit edge. Other arrangements may be contemplated where more than one edge is lit, or where it is desired to provide non-uniform backlighting for the image.

Referring to FIG. 4, approximately half the light scattered within light panel 10 tends to exit the rear of the light panel. This light is reflected back to and through the light panel 10 by the reflective back plate 20. In the preferred embodiment the back plate is made of 2 mm thick Dibond (a trademark of Alcan Composites USA Inc.) or equivalent white painted aluminum sheet. A gap 22 of 2-3 mm is provided between light panel 10 and back plate 20. Gap 22 facilitates the positioning between the back plate and the light panel of a digital display if an appropriate window is provided in the light panel and in the image-carrying sheet, as discussed below.

Referring to FIG. 5, a reverse 17 of the image to be illuminated may be directly printed digitally on the back (print side) of a ‘graphic front plate’ (image-carrying sheet 18) made of 2mm of an otherwise clear acrylic. Once the image has been printed, the surface of the image, again being the print side that faces the light panel 10, is then printed or silkscreened so as to uniformly cover the printed image with a translucent layer 15 of white. In the preferred embodiment, the translucent layer is 4 microns thick white ink and is applied using an ink-jet flatbed printer. The layer 15 appears to be effective to enhance the visibility and uniform brightness of the colors of the image 17. A suitable ink is Anapurna White G1 Ink by Agfa comprising 60-80% acrylate, 5-10% phosphine oxide, diphenyl and 1-5% benzophenone but it is believed that other inks may also be suitable provided that they provide a white translucent covering for the back of the image-carrying sheet.

The image-carrying sheet 18, the light panel 10 the backplate 20 and the gap 22 are retained in the assembly by a suitable frame for example an extruded housing 23.

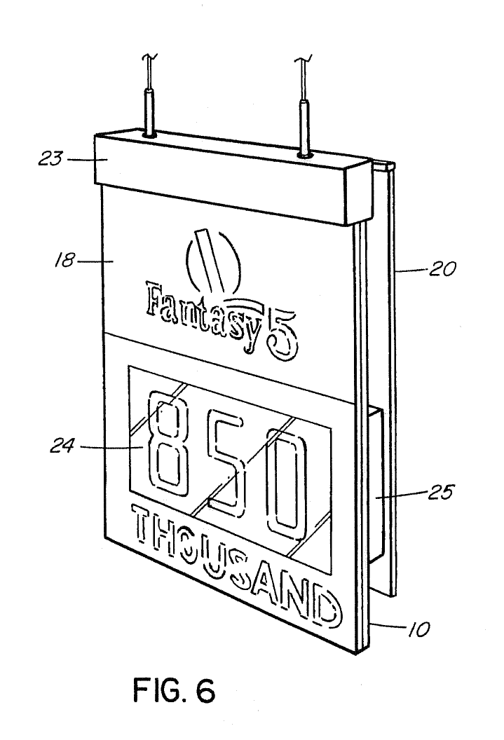

As seen in FIG. 4, light panel 10 and the image-carrying sheet 18 may be provided with overlapping transparent or clear windows (which may be cut-outs) 24, 26 allowing changeable digital information to be presented and viewed by means of a changeable digital display 25 secured behind the windows, resulting in a completed sign having the appearance shown in FIG. 6. This provides the opportunity for an illuminated image with both static and variable components.

Where a clear window is not required, an image-carrying sheet 18 that is translucent rather than transparent may be used. In such case, the image would be printed to the front of the image-carrying sheet 18 rather than a negative of the image being printed to the back of the sheet.

As the invention enables the use of printing for the image-carrying sheet, rather than engraving or etching, a customer can transmit the desired image to the sign maker who can then print directly from the image file provided by the customer.

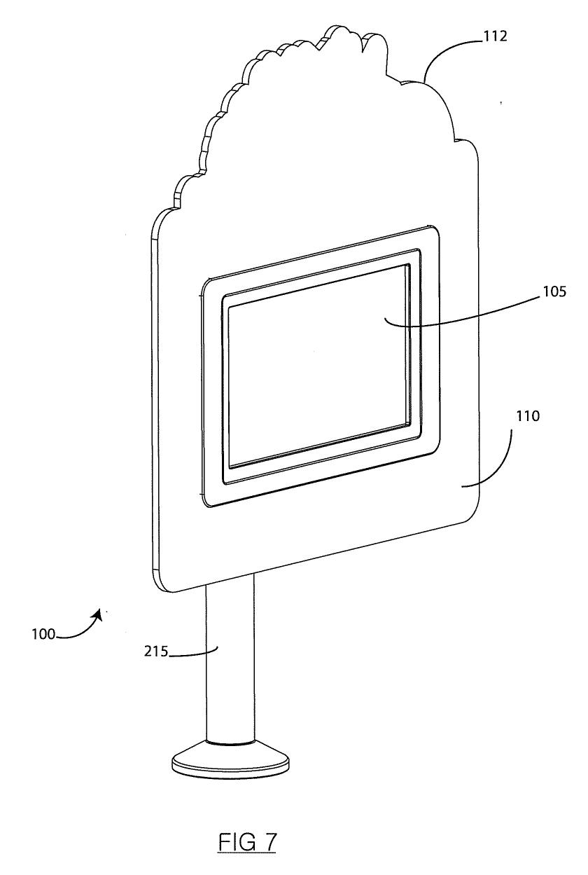

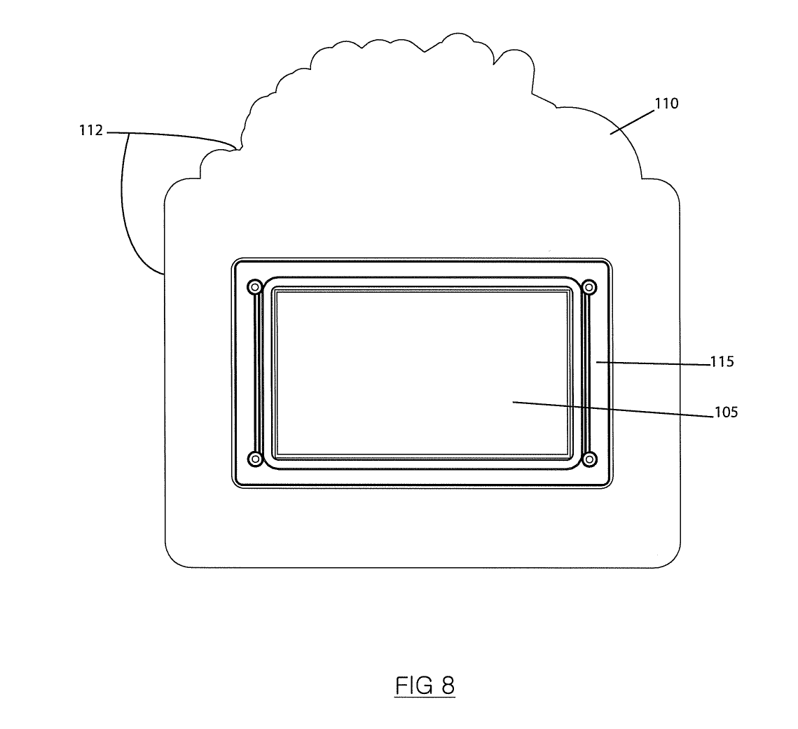

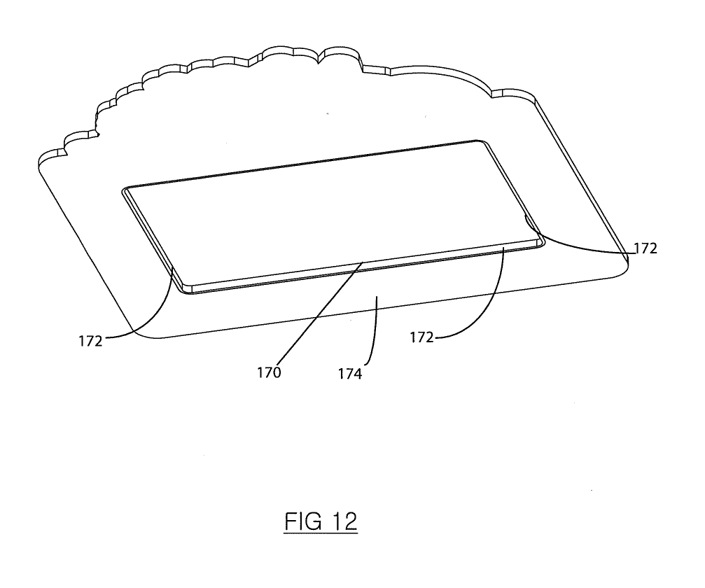

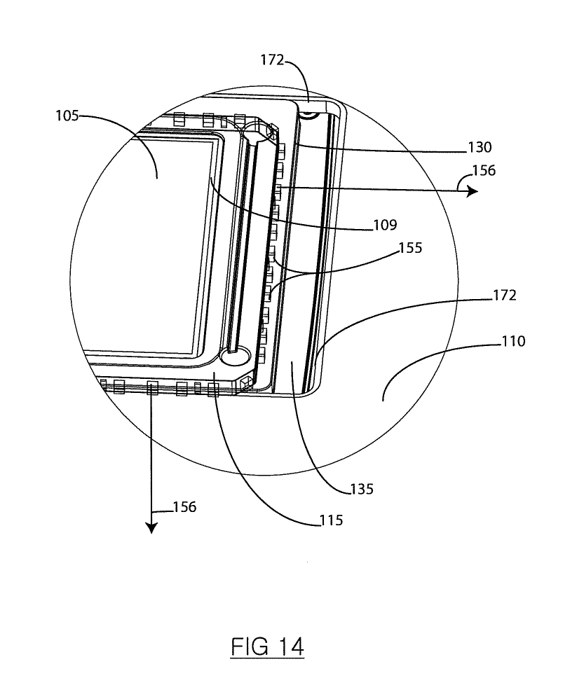

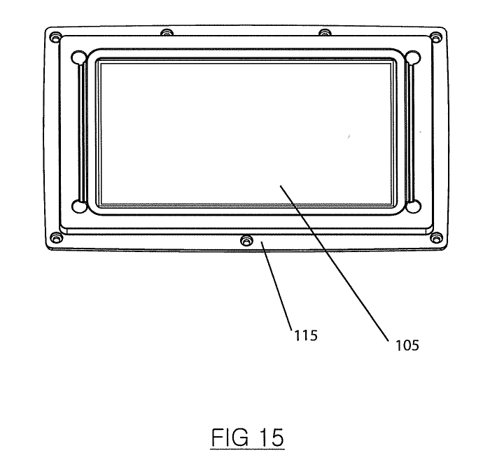

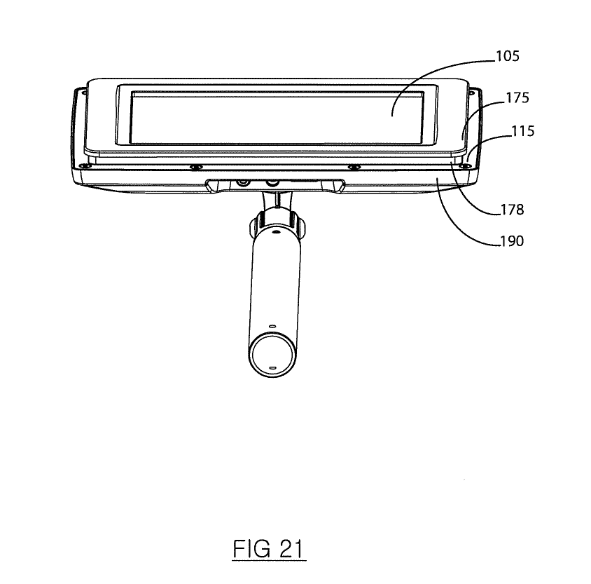

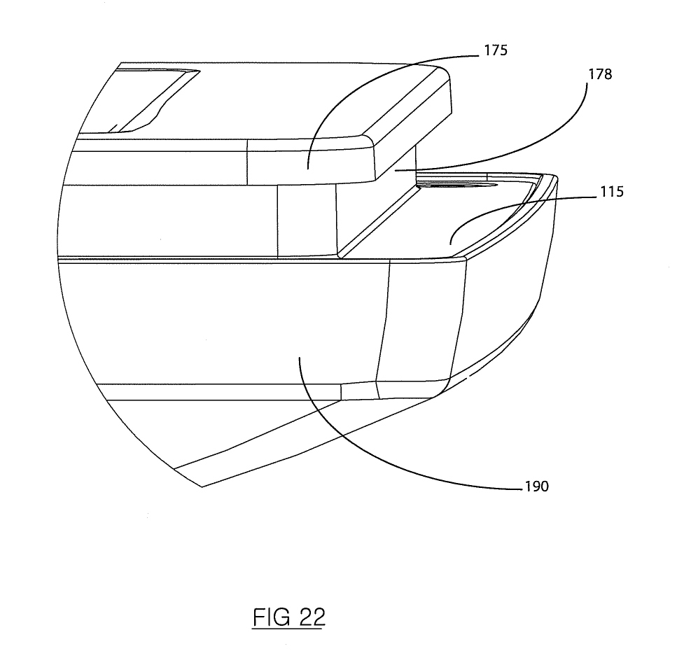

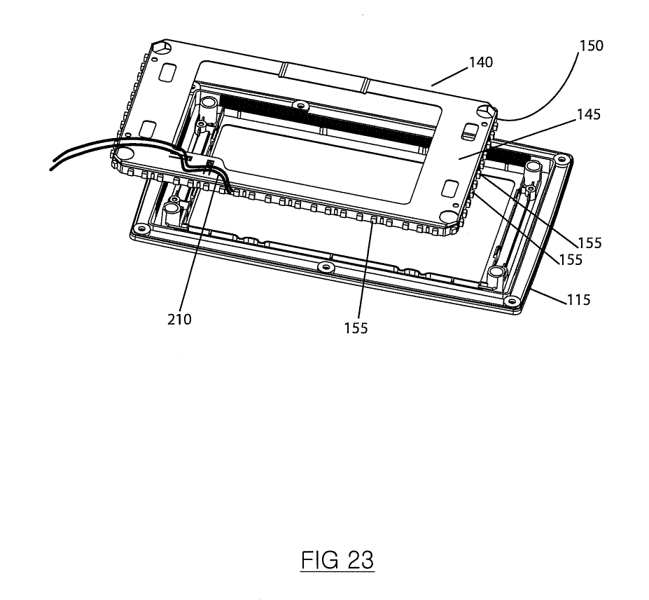

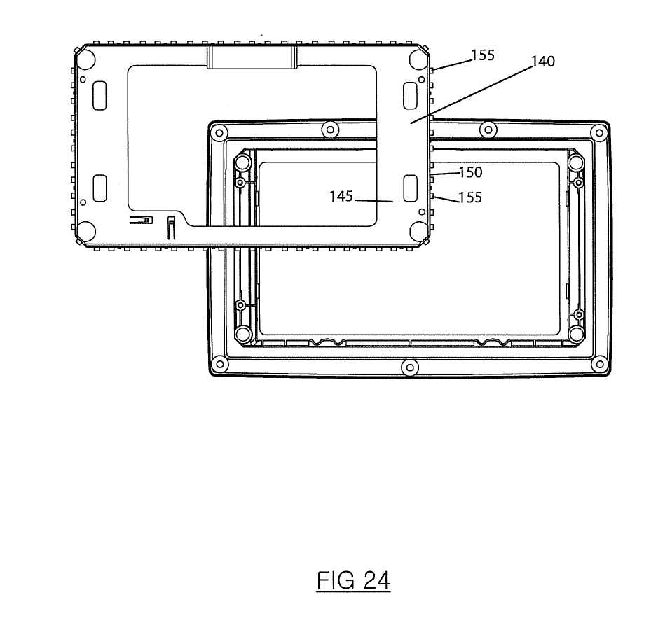

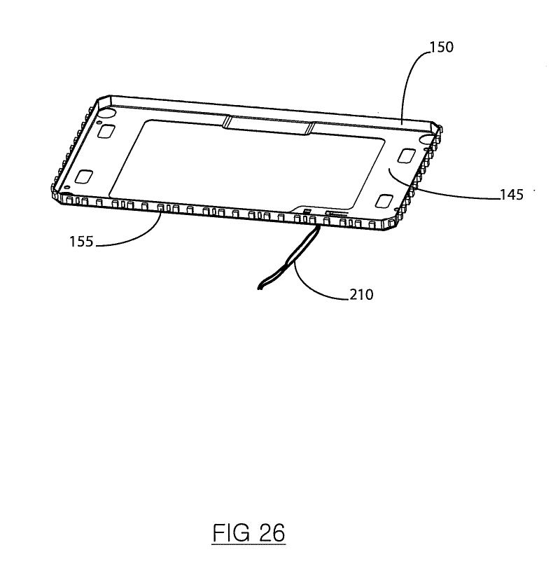

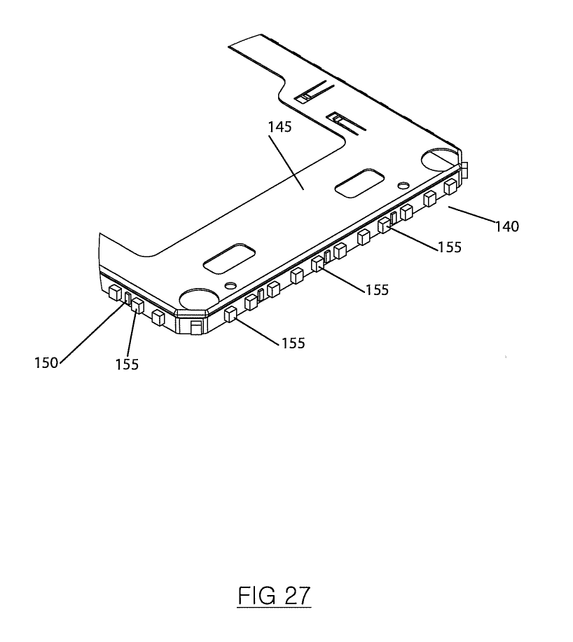

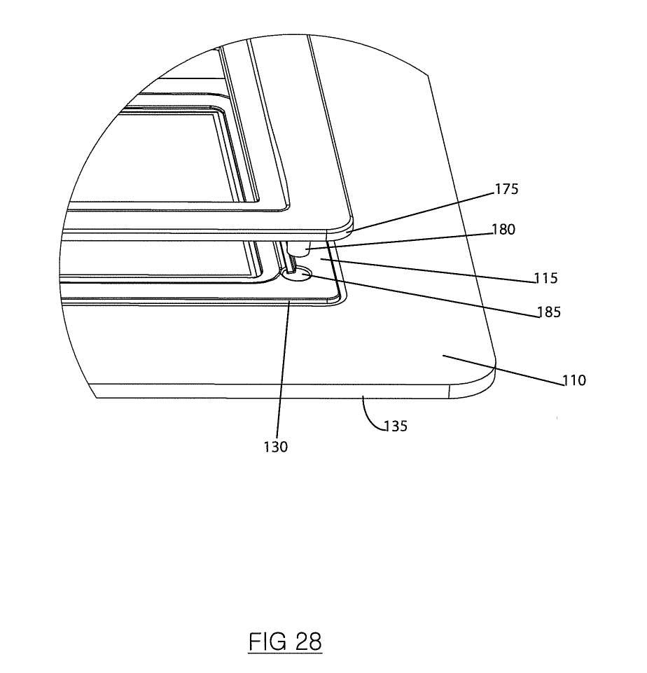

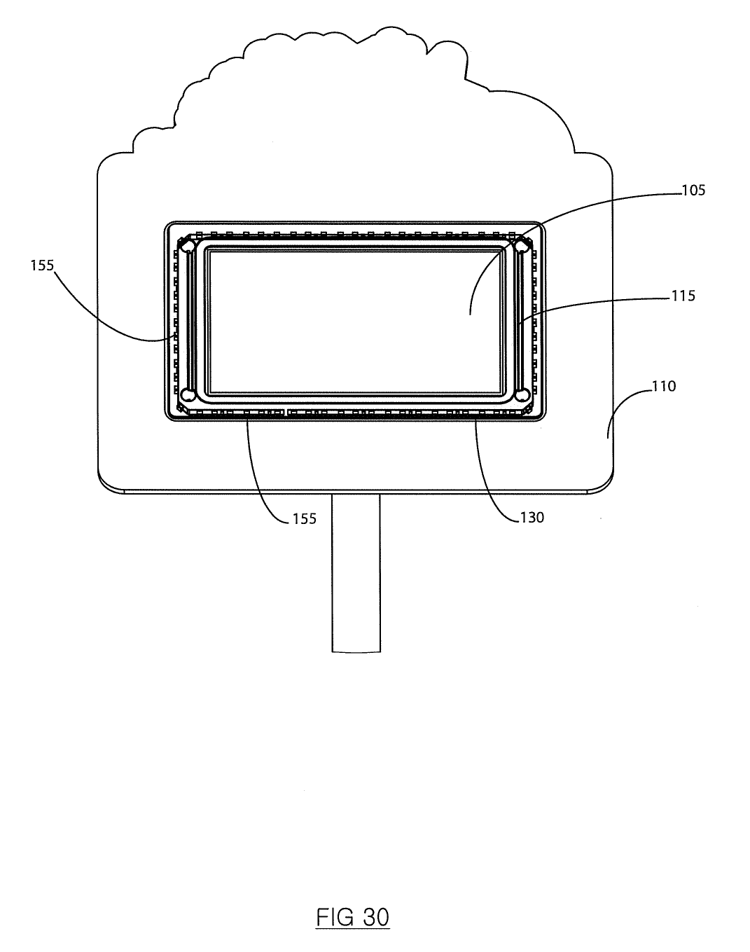

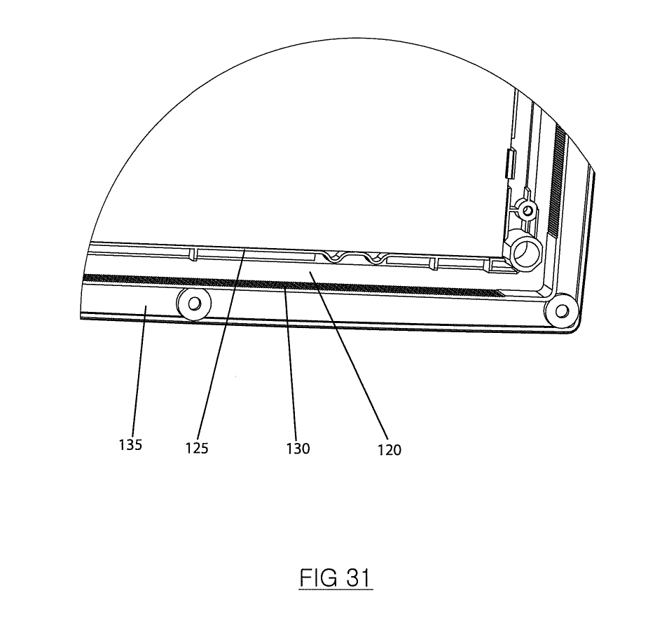

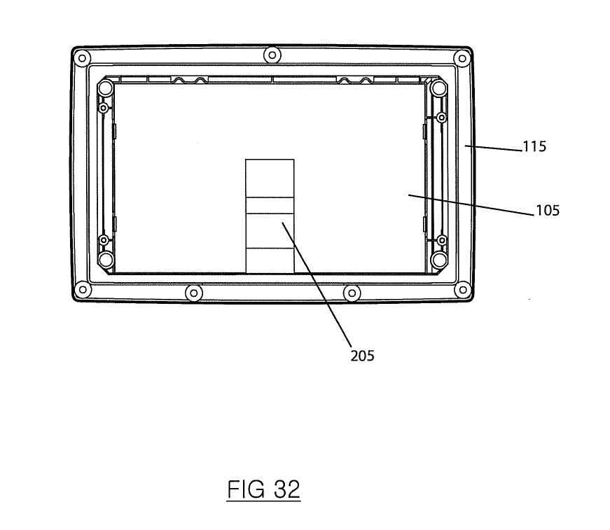

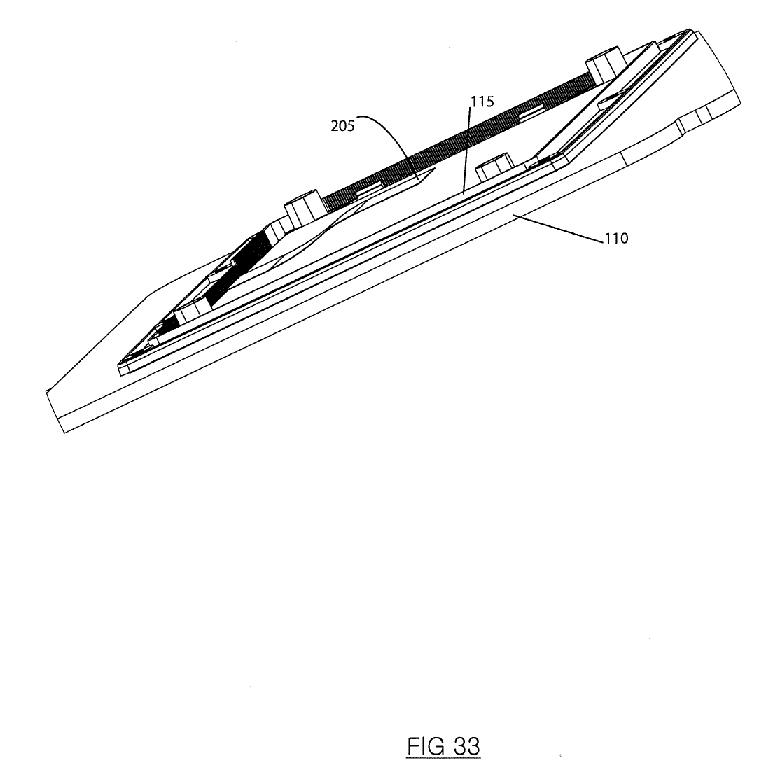

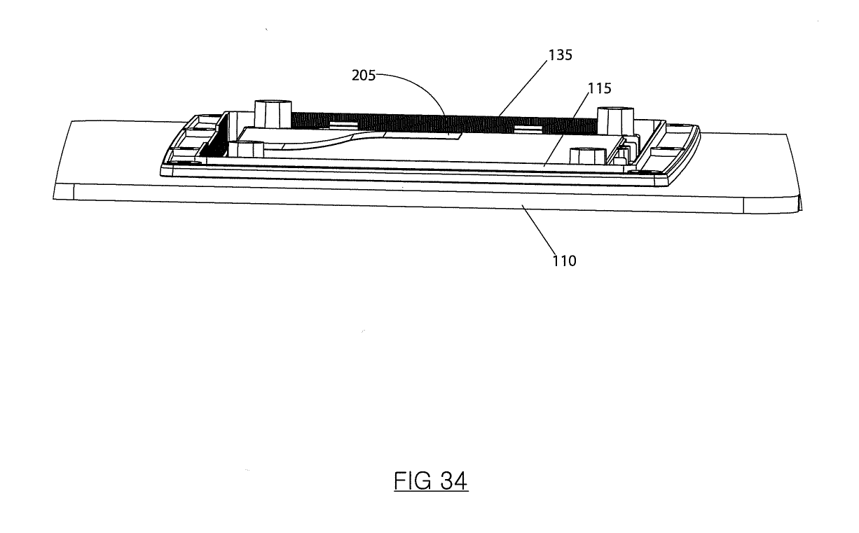

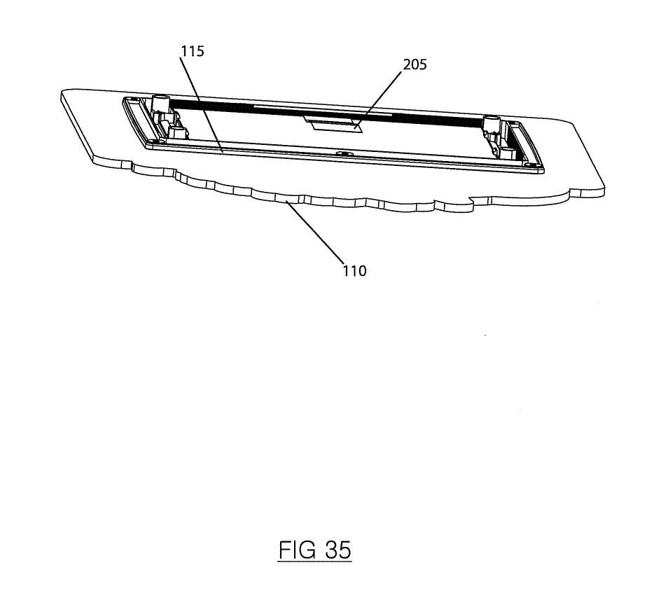

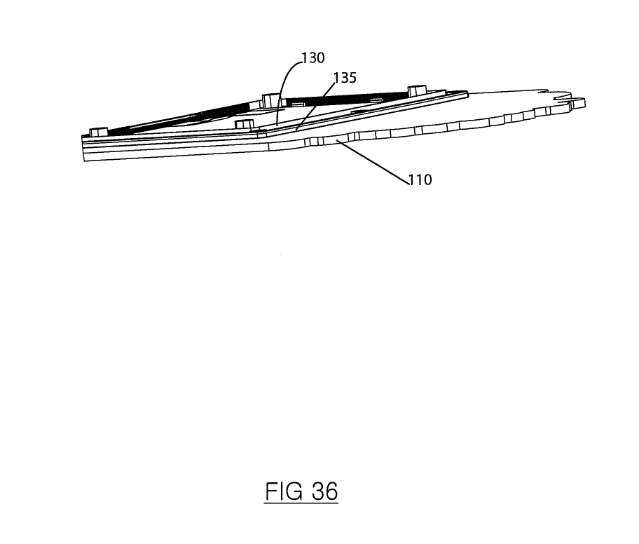

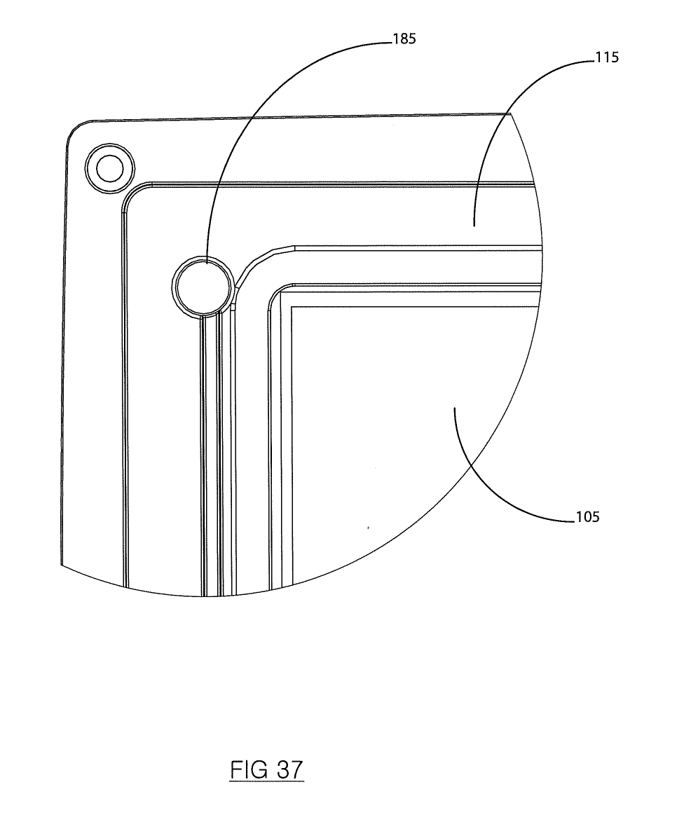

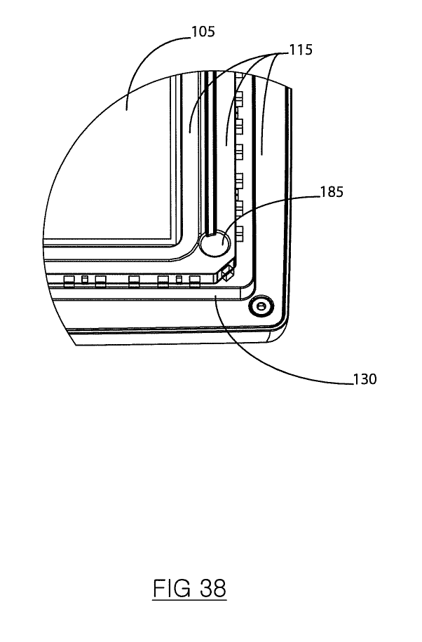

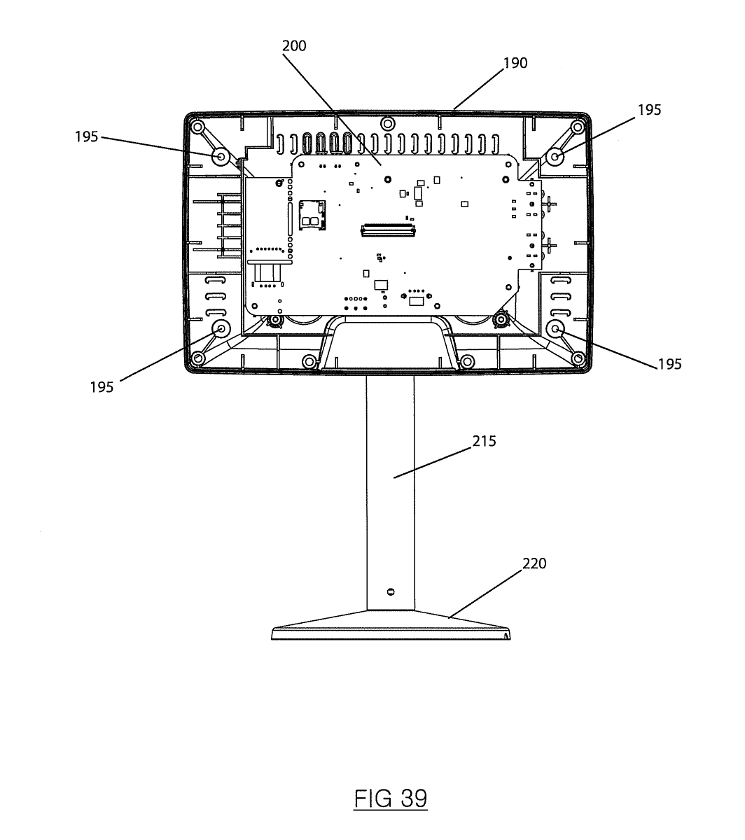

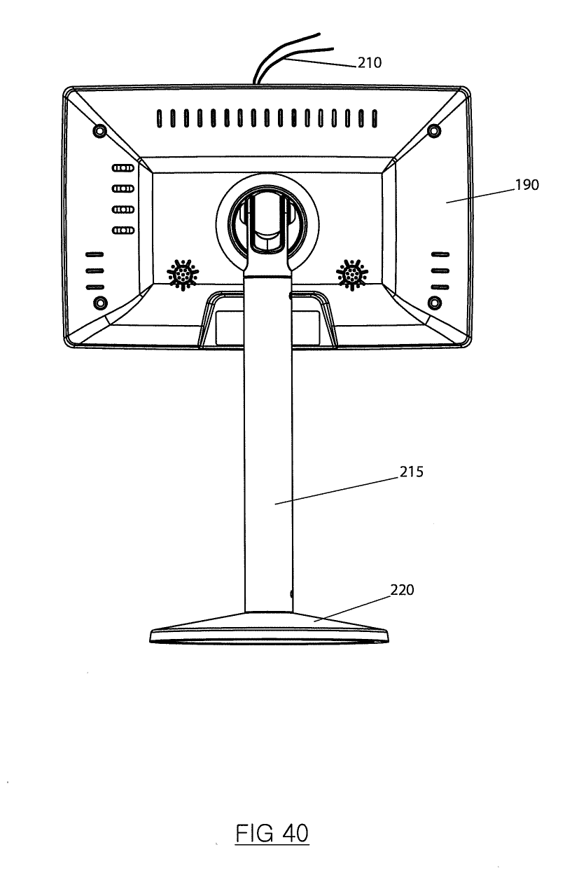

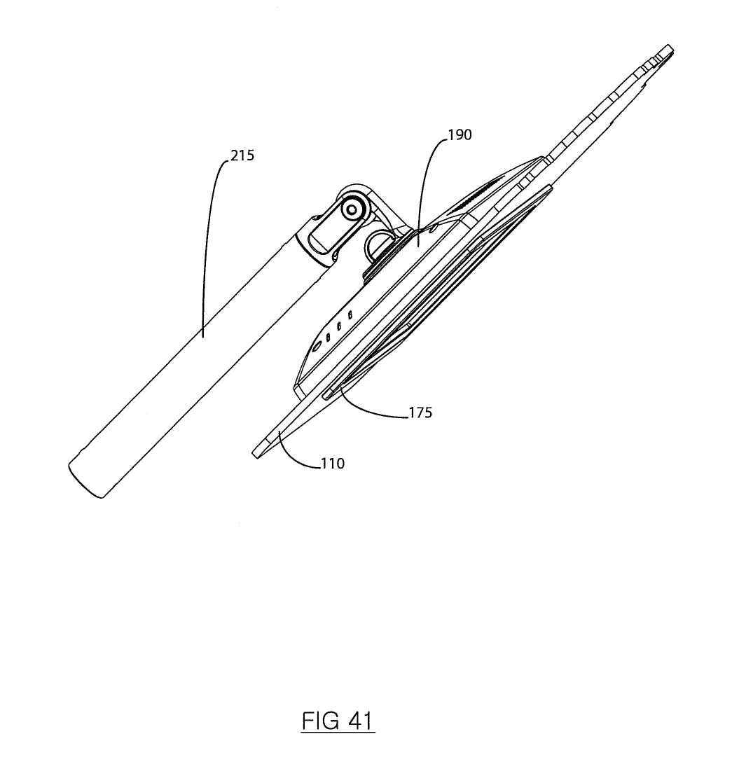

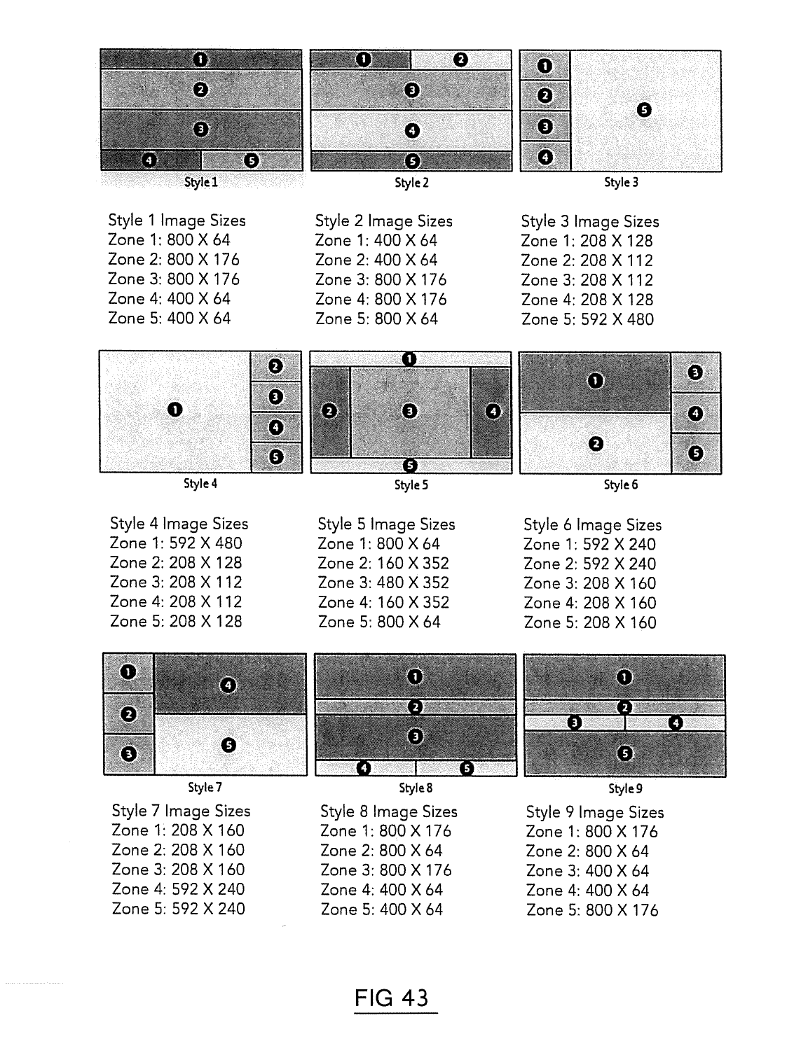

Another embodiment of a display assembly offering both static and variable components is illustrated in FIGS. 7 to 43. Referring to FIG. 7, display assembly 100 comprises a centrally disposed changeable digital display 105 that is substantially surrounded by an edge-lit panel 110 that acts as a surrounding faceplate.

The outer perimeter 112 of the faceplate 110 may take any number of shapes according to a customer's preference or specifications. As will be detailed below, lighting to illuminate the edge-lit faceplate is directed outward from the perimeter of the digital display 105 and into the side edges of the surrounding faceplate panel 110. Preferably, the faceplate 110 includes a static image printed thereon as shown in FIGS. 7 and 8, but the faceplate may also be provided without any particular image so as to nonetheless frame the digital display with an illuminated panel.

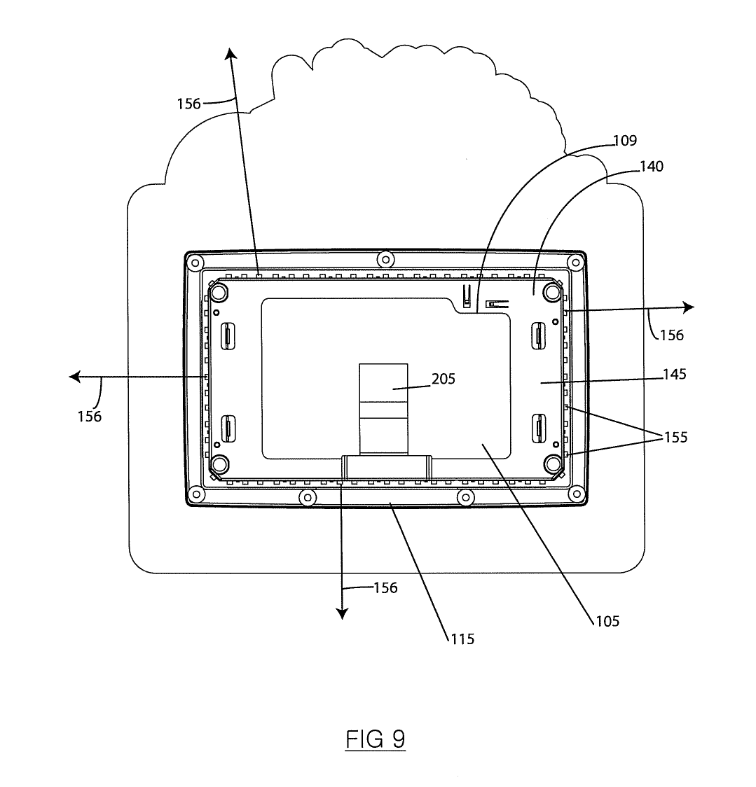

As is best seen in FIGS. 9-11 and 14, a plurality of light sources 155 are secured around the perimeter 109 of the digital display 105. The light sources 155 are directed radially outward (in the direction shown by arrows 156) from the digital display 105 into the inside edges 172 of the surrounding edge-lit faceplate 110.

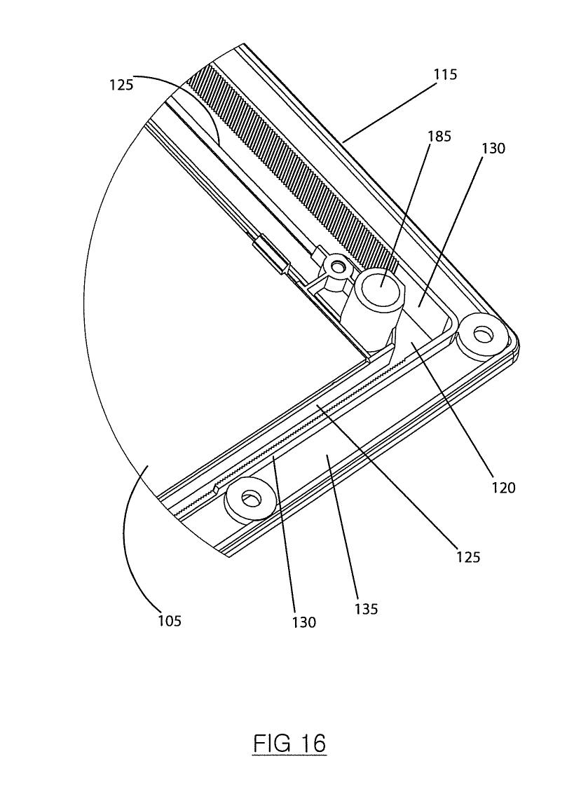

Referring primarily to FIGS. 15 and 16, the digital display 105 of this embodiment is mounted in a housing 115 that substantially surrounds the perimeter of the digital display 105. The housing 115 may be made for example of molded plastic. Housing 115 has a perimetral channel 120 in which the outwardly directly light sources 155 are to be housed.

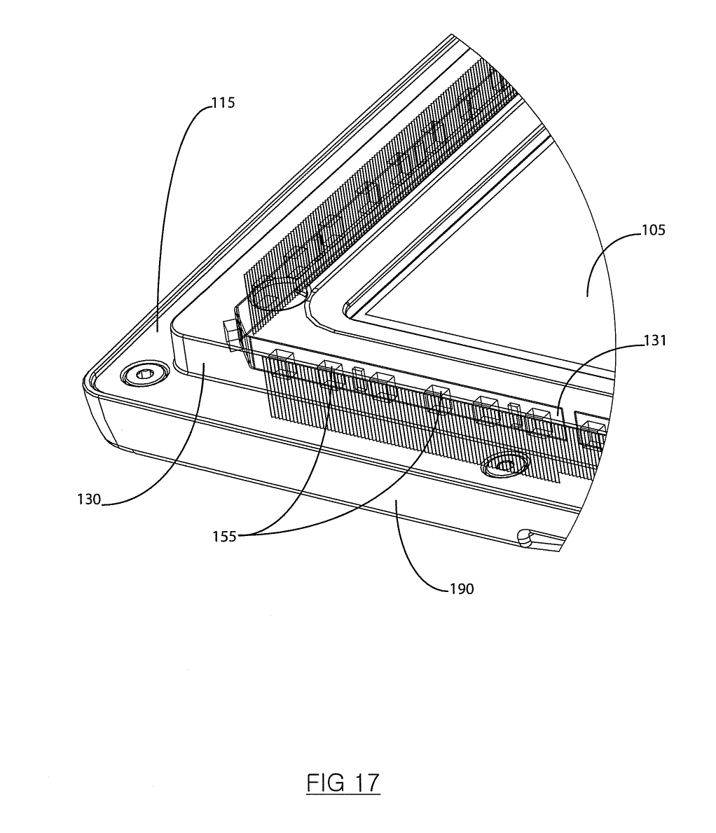

Channel 120 includes an outer wall 130 against which the edge-lit faceplate 110 abuts. As best seen in FIGS. 11 and 17, the outer wall 130 is provided with an uneven surface 131 to enhance diffusion of the light traversing the wall 130 into the edges 172 of the edge-lit faceplate 110 in the completed assembly.

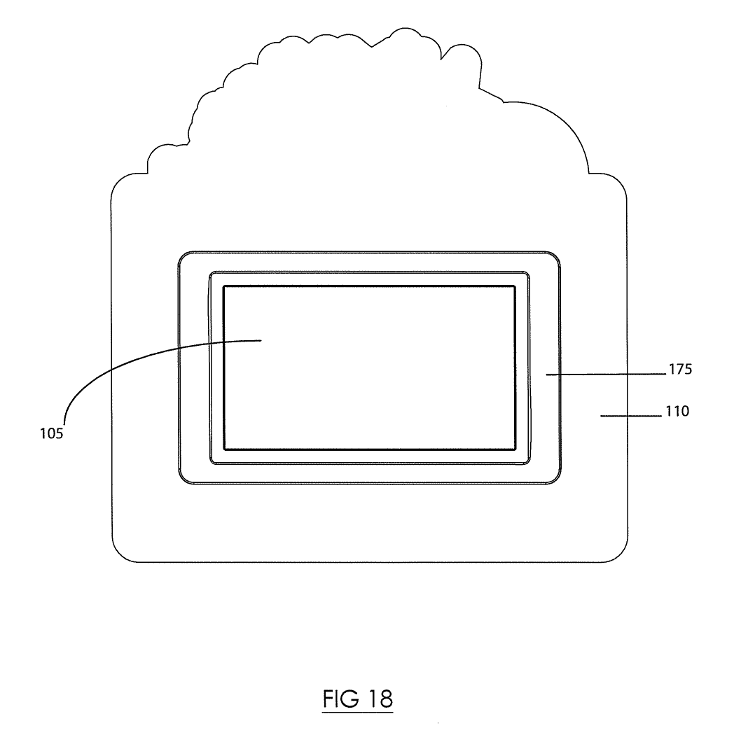

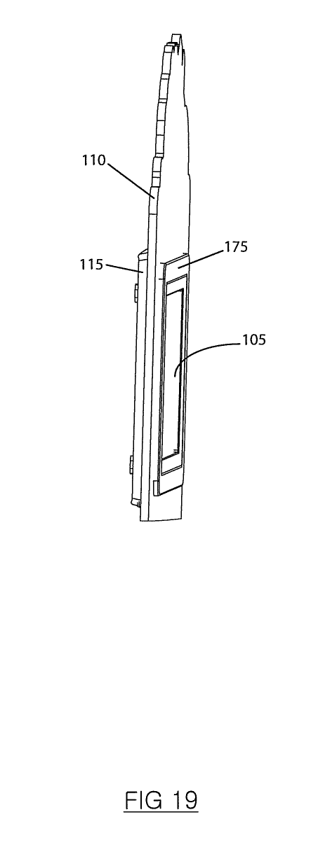

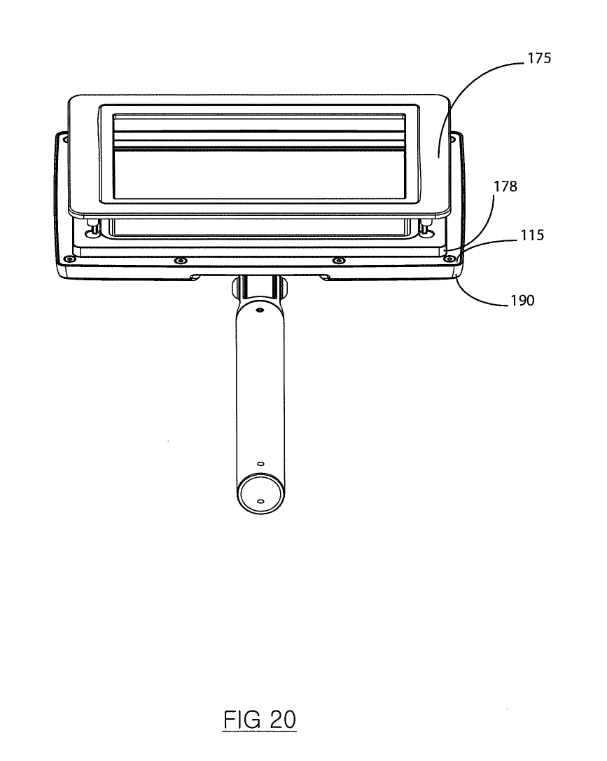

As seen in FIGS. 18 and 19, a bezel 175 is secured to the housing 115 to mask the light sources 155 from being seen from the front of the display assembly 100. The bezel 175 also serves to sandwich the faceplate 110 between the bezel 175 and the housing 115. The seat 178 formed between the bezel 175 and the housing 115 is best appreciated by reference to FIGS. 20, 21 and 22.

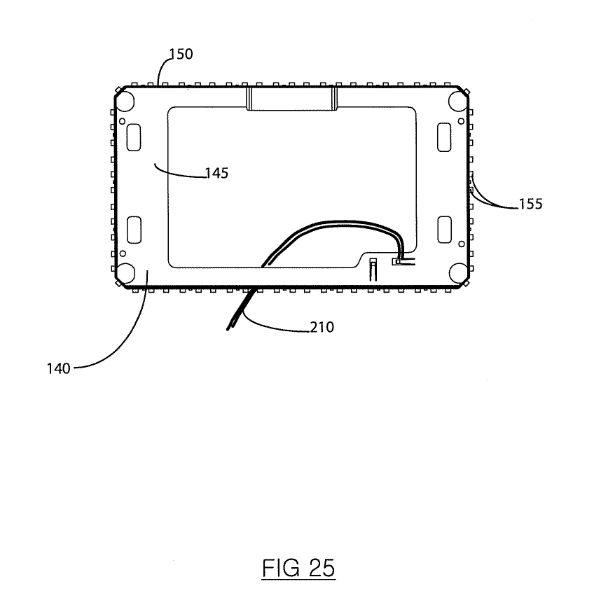

In the preferred version of this embodiment, the digital display 105 is an LCD screen and the light sources 155 are LEDs mounted on a chassis 140 that is seated in channel 120. Chassis 140 (on which the light sources 155 are mounted) is best illustrated in FIGS. 25-27. It comprises a substantially flat chassis surface 145 and a chassis wall 150 projecting substantially perpendicular to the chassis surface 145 and extending along the perimeter of the chassis surface 145. A plurality of LED lights 155 are affixed to the outer surface of the chassis wall 150. The LED lights 155 may be spaced apart from one another, but they extend along the entirety of the chassis wall 150, forming a perimeter around the chassis 140. The LED lights 155 are electrically connected to one another to allow for easier control and operation of all of the LED lights 155. Preferably, the LED lights 155 are oriented such that the emitted light is primarily directed outwardly and substantially perpendicularly to the surface of the chassis wall 150.

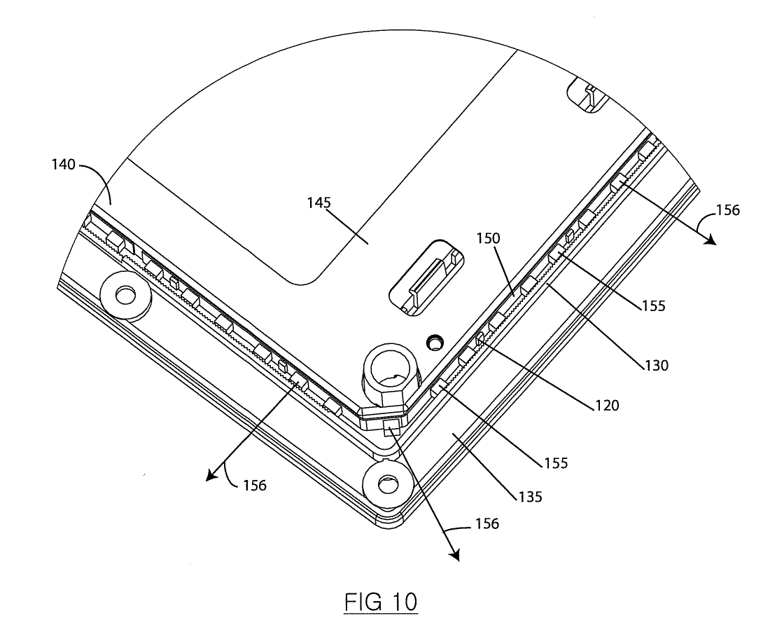

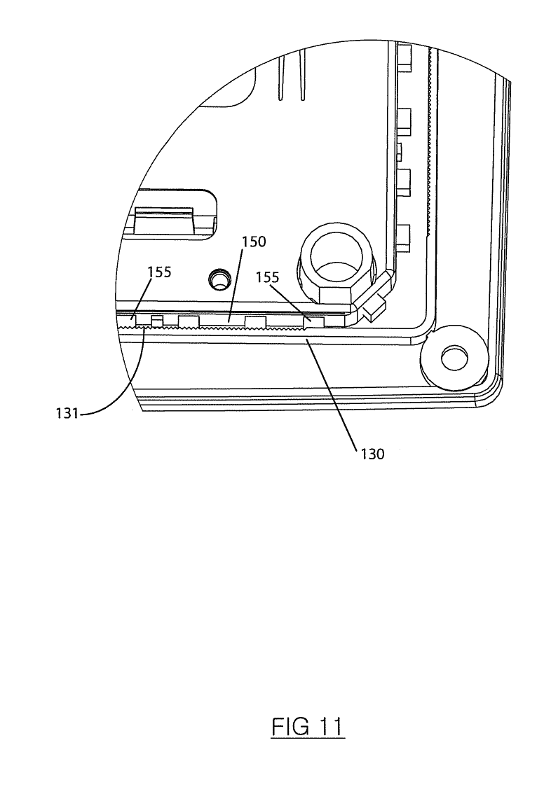

Referring to FIG. 15, channel 120 comprises an inner wall 125 and a transparent outer wall 130, which is spaced from the inner wall 125. A lip 135 projects outwardly from the outer wall 130 to act as a support surface for one side of the faceplate 110. The channel 120 opens on the side of the housing 115 that faces the rear of the display assembly 100. When the chassis 140 is seated in and secured to the housing 115, the chassis wall 150 abuts snugly into the channel 120 against its inner wall 125. FIG. 10 shows the chassis 140 seated in channel 120, although inner wall 125 is now obscured by wall 150 of the chassis that now abuts against it. The LED lights 155 fit within the space of channel 120 (i.e. between the inner and outer walls 125, 130). Because the outer walls 130 are transparent, the light emitted by the LED lights 155 is able to pass through the outer walls 130 of channel 120. In FIG. 17, the LEDs 155 are visible through the transparent walls 130 of the housing 115.

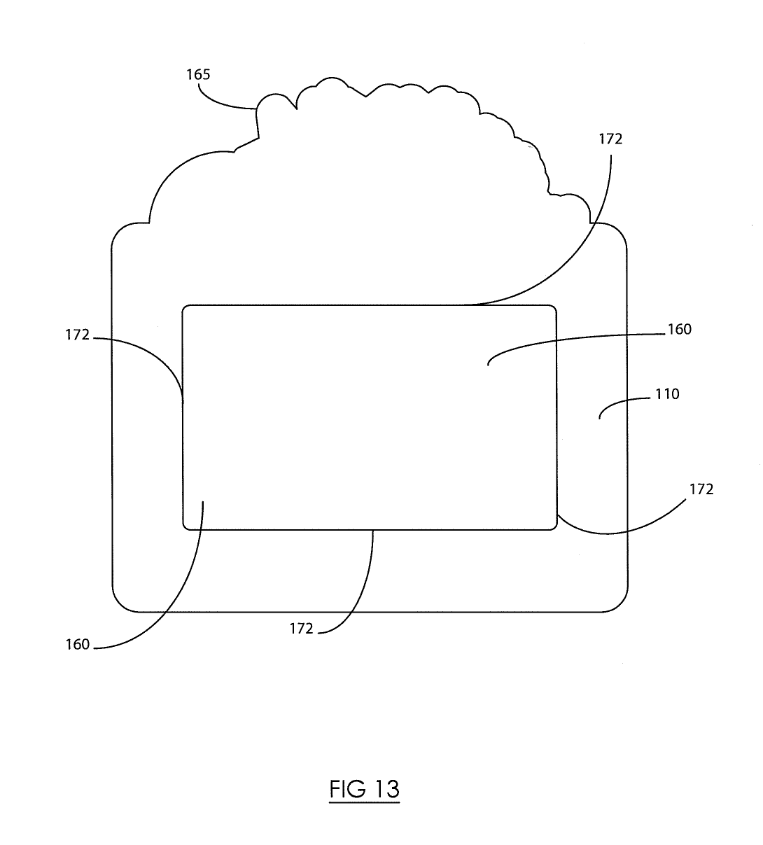

As seen by reference to FIGS. 13, 14, 28 and 31, an interior opening 160 of faceplate 110 is seated over lip 135 of housing 115 front of the housing 115. The opening 160 is sized such that when the faceplate 110 is placed over the front of the housing 115, the faceplate 110 snugly abuts the outer walls 130 of the channel 120 and rests on the lip 135. The faceplate 110 may comprise a printed surface 165 with a clear coating 170 on top of the printed surface 165 and a reflective backing 174 on the rear surface of the faceplate 110 The light from the LED lights 155 passes through the outer walls 130 of channel 120 to illuminate the printed surface 165 of the faceplate 110.

The faceplate 110 is secured in place by bezel 175 that sits over the faceplate 110, sandwiching the faceplate 110 against the housing 115. The bezel 175 comprises posts 180 extending from the rear of the bezel 175. The posts 180 extend into and through corresponding apertures 185 located on the housing 115. The posts 180 and the apertures 185 assist in ensuring that the bezel 175, faceplate 110, and the housing 115 are aligned correctly. When the bezel 175 is placed over the faceplate 110 and the housing 115, the bodies of the LEDs 155 on the chassis 140 are not visible from the front as they are hidden from view by the bezel 175.

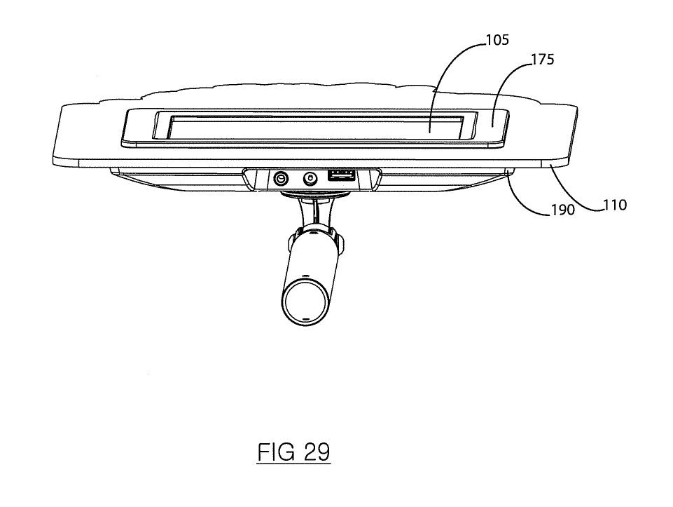

Referring now to FIGS. 29 and 39-41, the display assembly 100 further comprises a rear housing 190. The bezel 175, the faceplate 110, and the housing 115 are attached to the rear housing 190. The rear housing comprises one or more housing receptacles 195 that correspond in location to the posts 180 of the bezel 175. The posts 180 fit within the housing receptacles 195 and by using suitable fasteners, such as screws to engage the housing receptacles 195 so that the bezel 175 (along with the faceplate 110 and the housing 115) may be securely attached to the rear housing 190. The rear housing 190 further comprises a circuit board 200 for providing control functions for the digital assembly 100. A ribbon connector 205 provides data and power from the circuit board 200 to the digital display 105. An LED power connector 210 provides power from the circuit board 200 to the LED lights 155.

A lower mount 215 may extend from the bottom of the rear housing 190. The mount 215 may comprise a base 220 that allows the digital assembly 100 to be placed on a flat surface. One or more buttons may be present on the rear housing 190 to allow for the user to control and operate the display assembly 100.

The display assembly 100 provides for the digital display 105, which is capable of displaying both static images and video, to be surrounded by an edge-lit illuminated signage.

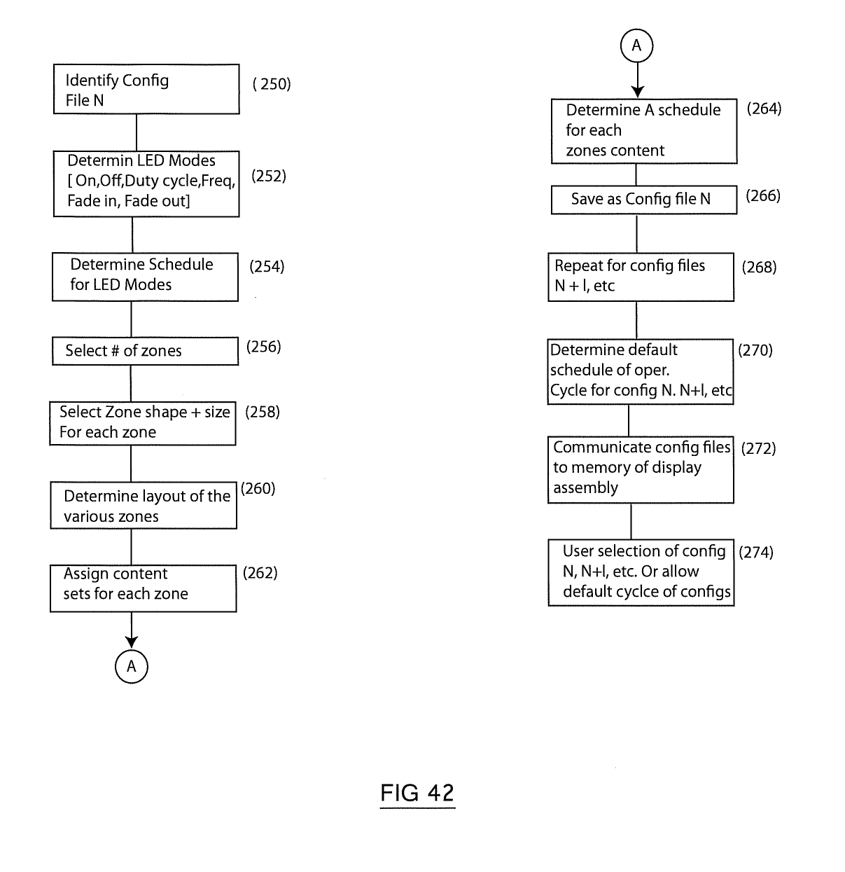

The invention further provides that the contents of the digital display 105 may be customized and controlled by the user, either wirelessly or manually by connecting a suitable media device (preferably a USB drive) to a port on the rear housing 190. User interface software is made available to users to configure the display modes of digital display portion of the assembly, as well as the LEDs that illuminate the faceplate. The user interface software allows the user to create any number of display configurations that are saved to memory as generally illustrated by the flowchart of FIG. 42. Once saved, the configurations may be communicated to the display assembly by a wireless network connection that is enabled by on-board networking software and wireless communication hardware or by means of a USB drive in the USB port of the rear housing 190.

Once the configurations have been communicated to the display assembly, they are saved (272) in memory on the circuit board 200. The user may thereafter allow the display assembly to operate according to a schedule to sequence the various configurations, or according to a specific one of the configurations, which may itself have a particular schedule associated with it as described below.

The display configurations include the ability of the user to determine (252) the lighting status and mode of the LEDs 155 that illuminate the faceplate 110. This can include having the LEDs on, off or flashing according to a particular frequency and duty cycle, and fade in and fade out features. The operation of the LEDs is also customizable according to a schedule, allowing the user to select a particular state of operation according to a user-determined schedule (254).

The contents of the digital display 105 may also be customized by dividing the digital display 105 into a plurality of virtual zones. For example, the user may define a number (256) of display zones 1, 2, 3, 4, 5 such as are shown in FIG. 42. The shape and size of each zone is determined by the user (258). The virtual zones are specified through the user interface and the parameters of each zone are communicated (272) to the memory on circuit board 200 as part of the display configurations. Although five zones are illustrated in FIG. 42, any number of zones may be allowed. In the preferred embodiment, up to six zones are allowed, with the user having the ability to determine the shape (preferably rectangular) and size of each zone, as well as the layout (260) of the zones in relation to one another.

These pre-configured layouts allow the user to quickly switch between different layouts without the need to re-define the dimensions or locations of the zones 1, 2, 3, 4 and 5 each time a specific layout is needed. Instead, the user simply chooses from one of the pre-configured layouts and proceeds to specifying the content of the zones 1, 2, 3, 4 and 5. The pre-configured layouts may also be later edited and saved by the user.

The user interface also allows the user to define (262) the content of each zone in each layout, be it video or a static image. A plurality of alternative contents may be defined as a contents set for each zone to accommodate a scheduling of the content for each zone.

The layout of the zones and which content from the content set will be played may be controlled by a schedule (264), which allows the contents to be set according to the time or date. For example, the contents of the digital display 105 may be set up so that one layout with particular content in each zone appears between 12:00 am and 12:00 pm, while another layout (perhaps with differing sizes, numbers, locations, and/or content of the zones 1, 2, 3, 4 and 5) appears between 12:00 pm and 12:00 am. In another example, the contents may be set up so that one layout appears from Monday to Friday, and another layout appears on Saturday and Sunday. This may be pre-programmed into the digital display 105.

The ability to pre-program or change the display content according to zones enables a user to customize the presentation of the digital display 105 component of the display assembly 100 without necessarily changing the entirety of the content of the digital display. For example, a user may pre-configure a plurality of contents for, for example, two out of five zones, and using a schedule, determine which of the contents will be played (in the case of video) or shown (in the case of a static image) at a given time. This approach avoids the need to create an entire composite display for each scheduling time segment, thus making it easier for a user to change the overall display from time to time. It also makes it easier for a user to modify the digital display without necessarily changing all aspects of the display.

It will be appreciated by those skilled in the art that the preferred and alternative embodiments have been described in some detail but that certain modifications may be practiced without departing from the principles of the invention.

1. A display assembly comprising:
a digital display;
an edge-lit illuminated panel substantially surrounding said digital display; and,
a plurality of light sources secured around said digital display, said light sources being oriented to illuminate radially outward from the perimeter of said digital display and into inner edges of said panel.

2. A display assembly as in claim 1 further comprising a bezel surrounding said digital display so as to obscure said light sources from sight from the front of said digital display.

3. A display assembly as in claim 1 or 2 further comprising a computer readable medium having stored thereon instructions that when executed define a plurality of distinct image zones within said digital display, each of said image zones being selectively associated with content selected from among the group comprising: a static digital image, video.

4. The display assembly of claim 3 further comprising a computer readable medium having stored thereon instructions that when executed associate a schedule of content display with at least one of said zones.

5. A display assembly comprising a digital display, an edge-lit illuminated panel substantially surrounding said digital display and a computer readable medium having stored thereon instructions that when executed define a plurality of distinct image zones within said display screen, each of said image zones being selectively associated with content selected from among the group comprising: a static digital image, video.
